(19) United States
(12) Patent Application Publication
(10) Pub. No.: US 2004/0141246 A1
(43) Pub. Date: Jul. 22, 2004

(54) Hard disk drive host protected area duplication

(75) Inventor: James L. Kroening, Dakota Dunes, SD (US)

Correspondence Address: GATEWAY, INC., SCOTT CHARLES RICHARDSON, 610 GATEWAY DRIVE, MAIL DROP Y-04, NORTH SIOUX CITY, SD, 57049, US

(73) Assignee: Gateway, Inc.

(21) Appl. No.: 10/346,942

(22) Filed: Jan. 17, 2003

(51) Int. Cl. G11B 5/86

(52) U.S. Cl. 360/15

(57) ABSTRACT

A hard disk drive is duplicated by copying a data area of a source hard disk drive to a target hard disk drive. A host protected area (HPA) of a source hard disk drive is detected if the source hard disk drive has a host protected area, and the host protected area of the source hard disk drive is copied to the target hard disk drive if a host protected area was detected on the source hard disk drive.

### FIELD OF THE INVENTION

The invention relates generally to hard disk drive duplication, and more specifically to a hard disk drive host protected area duplication system and method.

### BACKGROUND OF THE INVENTION

Manufacturers of computer systems typically wish to provide the system to customers or end users configured so that the computer is usable for basic functions with little or no end user configuration. An operating system is usually installed and configured with specialized drivers to work with the hardware in a particular system, and commonly used applications such as web browsers, word processors, and other software are often installed and configured. The operating system, software, and configuration information are stored on a hard disk drive, so that when and end user starts the computer it will boot the operating system from the disk drive, which also stores other software and configuration data. This allows the end user to simply boot a new computer and begin using it without extensive further configuration.

Because computer manufacturers usually produce many of the same model of computer, each similarly equipped and configured, it is not efficient for the manufacturer to manually install and operating system, manually install other software, and manually configure each system that is sold. Instead, one such system is typically configured, and the contents of the disk drive that stores the operating system, software, and other configuration information are copied to multiple other disk drives to be put in multiple similarly configured machines. The copy is performed by doing a bit-by bit copy of one hard disk drive to another, or by copying sector-by-sector or file-by file to each of the multiple other disk drives. When the other drives are installed in other similarly equipped computer systems, this effectively copies the configuration data, operating system, and software stored on the hard disk of the original computer to the multiple other computers so that they are each able to boot from their copied hard disk drives and execute software without further extensive configuration.

But, while such a method of copying data from one hard disk to another can copy operating system, software, and some other configuration data, it cannot copy a certain protected area of a hard disk drive known as a Host Protected Area (HPA). The HPA provides a storage area on a hard disk drive that cannot be accessed via conventional hard disk methods, and is intended to be used for storing critical system data such as BIOS or system management information. Some computer systems also use the HPA to store the contents of main memory when a computer system is suspended, so that the information can be loaded back to memory to resume when the system is restarted. But, because conventional hard disk commands cannot access or therefore copy this data, it cannot be copied with these hard disk duplication machines or utilities.

### SUMMARY OF THE INVENTION

A system and method of copying a source hard disk drive to one or more target hard disk drives is provided. In one embodiment, a data area of a source hard disk drive is copied to a target hard disk drive. A host protected area (HPA) of a source hard disk drive is detected if the source hard disk drive has a host protected area, and the host protected area of the source hard disk drive is copied to the target hard disk drive if a host protected area was detected on the source hard disk drive.

### BRIEF DESCRIPTION OF THE FIGURES

FIG. 1 shows a computerized hard disk drive duplication system, consistent with an embodiment of the present invention.

FIG. 2 shows a flowchart of operation of an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in the various embodiments described herein a system and method of copying a source hard disk drive to one or more target hard disk drives. In one embodiment, a data area of a source hard disk drive is copied to a target hard disk drive, and a host protected area (HPA) of the source hard disk drive is copied to a target hard disk drive. The HPA of the source hard disk drive is copied to the target hard disk drive only if a computerized system detects that the source hard disk drive has a host protected area, and the host protected area of the source hard disk drive is copied to the target hard disk drive if a host protected area was detected on the source hard disk drive.

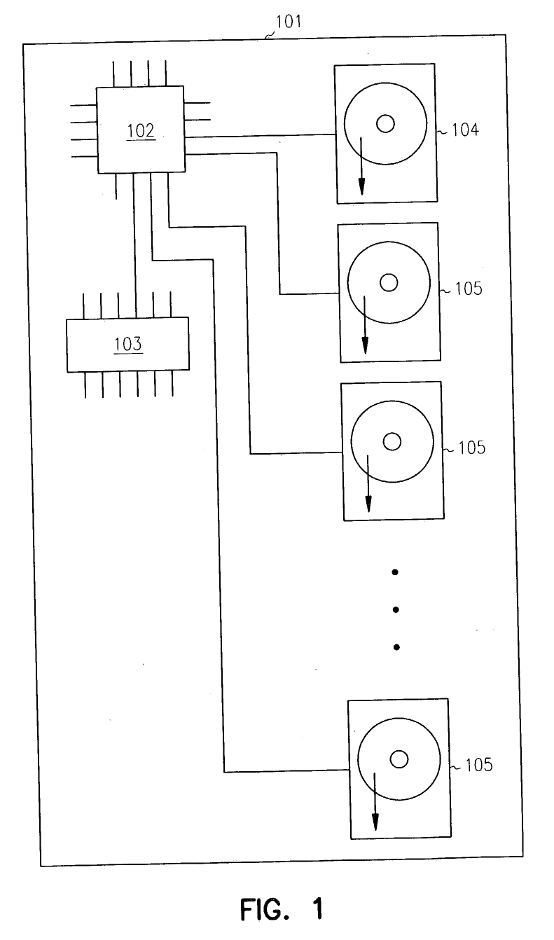

FIG. 1 illustrates a computerized hard disk duplication system, consistent with an embodiment of the present invention. The system 101 comprises a computerized controller 102, which executes code that is operable to perform various hard disk functions. In some embodiments of the invention, the executed code is loaded from firmware or memory 103, but in other embodiments of the invention is loaded from a diskette, compact disc, or other device.

The code in this particular example embodiment of the invention copies data form the data area of source hard disk drive 104 to one or more target hard disk drives 105. The present invention further checks the source hard disk 104 for a host protected area, and if one is found creates a corresponding host protected area on each of the target hard disk drives 105. The system then copies the host protected area data from the source disk 104 to the target disks 105, and closes the host protected area so that it is again protected. The system 101 can in this way duplicate both the data area of a hard disk drive which is accessible using conventional hard disk drive methods and the host protected area which is not accessible without special hardware.

In one embodiment of the invention, the host protect area is copied by reading the location of the host protected area from the source disk drive 104 and opening the host protected area of the source disk. The data can then be read, and a corresponding host protected area on the target disk drives 105 is defined and recorded in the disk configurations of the target hard disk drives 105. After the host protected area data is copied from the source disk 104 to the target disks 105, the host protected areas on the target disk drives 105 and on the source disks 105 are again protected, so that the host protected areas are protected from access using conventional disk drive operations.

The hard disk's host protected area is in some embodiments of the invention defined by storing a logical block address (LBA) range for the host protected area in the disk configuration information of the hard disk drive. The data area is then defined to have a logical block address range not including the host protected area, so that conventional disk drive operations cannot manipulate the host protected area. Access to the host protected area is performed by special operations redefining the range of accessible logical block addresses, which are changed back to include only the data area after host protected area operations are complete.

In situations where the source disk drive 104 and the target disk drives 105 are not the same size, some embodiments of the present invention will create a host protected area on the target disk drives that are the same size but not in the same location or logical block addresses as the host protected area on the source disk drive 104. This enables duplication of a single configuration image from the source disk drive 104 to several target disk drives 105 of varying sizes, so that a manufacturer may use a single source configuration drive's data to prepare and configure similar computer systems configured with disk drives of varying sizes.

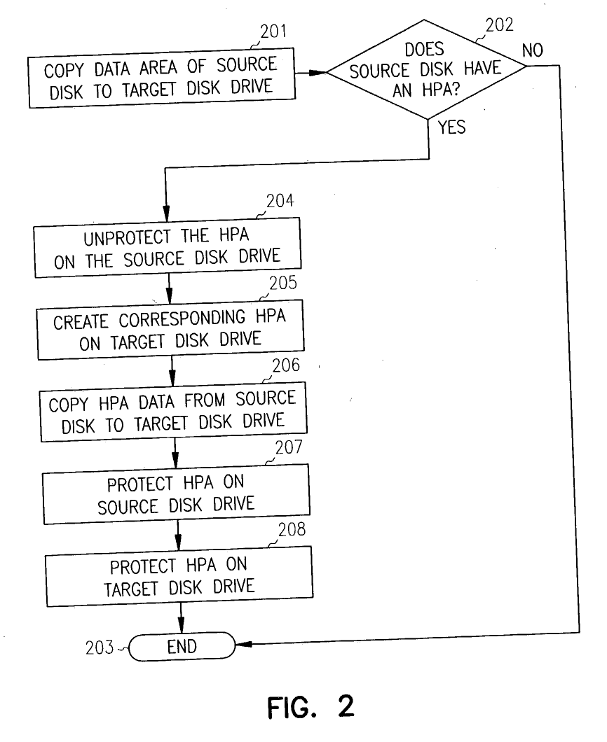

FIG. 2 is a flowchart of a method of practicing the present invention. The data are of the source disk drive is copied to the target disk drive (or in alternate embodiments, to the target disk drives) at 201. The source hard disk drive is searched for a Host Protected Area (HPA) at 202. If a HPA is not found, the copy process proceeds to the end 203. If a HPA area is found, the HPA on the source disk is unprotected at 204 so that the data from the HPA may be read and copied.

A Host Protected Area (HPA) is created on the target disk drive at 205, such that the HPA on the target disk drive corresponds to the HPA on the source disk drive. Then, the data can be copied from the HPA on the source disk drive to the HPA on the target disk drive at 206. After the HPA data is copied, the HPA on the source disk is closed at 207 and the HPA on the target disk is closed at 208. The process then proceeds to the end 203.

Although FIGS. 1 and 2 are discussed in terms of a computerized hard disk duplication machine, these are but example embodiments of the present invention. Various methods and apparatus consistent with the present invention will include personal computers configured to address multiple hard disk drives, specialized computer systems with firmware or ROM code operable to carry out the present invention, and a variety of other such methods and systems.

The descriptions of the present invention presented here are examples of implementation of the present invention, and show by way of illustration ways in which the present invention may be practiced. Many other methods and apparatus may be consistent with the present invention, which is limited only by the appended claims. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A method of duplicating a source hard disk drive, comprising:
copying a data area of a source hard disk drive to one or more target hard disk drives;
detecting a host protected area (HPA) of a source hard disk drive if the source hard disk drive has a host protected area; and
copying the host protected area of the source hard disk drive to the one or more target hard disk drives if a host protected area was detected on the source hard disk drive.

2. The method of claim 1, wherein copying the host protected area of the source hard disk drive to the one or more target hard disk drives comprises:
creating a host protected area on the one or more target hard disk drives; and
copying data from the host protected area of the source hard disk drive to the created host protected areas on the one or more target hard disk drives.

3. The method of claim 2, wherein creating a host protected area on the one or more target hard disk drives comprises defining a logical block address LBA range on the one or more target hard disk drives for the host protected area.

4. The method of claim 2, wherein creating a host protected area on the one or more target hard disk drives comprises defining a size of the host protected area on the one or more target hard disk drives.

5. The method of claim 2, further comprising protecting the host protected area on the one or more target disk drives after the creation of a host protected area and the copying of data to the host protected area are complete.

6. The method of claim 1, wherein the method is implemented in a hard disk drive duplication machine.

7. A method of copying source hard disk data to one or more target hard disk drives, comprising:
detecting a host protected area of a source hard disk drive if the source hard disk drive has a host protected area; and
copying the host protected area of the source hard disk drive to the one or more target hard disk drives if a host protected area was detected on the source hard disk drive.

8. The method of claim 7, wherein copying the host protected area of the source hard disk drive to the one or more target hard disk drives comprises:
creating a host protected area on the one or more target hard disk drives; and
copying data from the host protected area of the source hard disk drive to the created host protected areas on the one or more target hard disk drives.

9. The method of claim 8, wherein creating a host protected area on the one or more target hard disk drives comprises defining a logical block address LBA range on the one or more target hard disk drives for the host protected area.

10. The method of claim 8, wherein creating a host protected area on the one or more target hard disk drives comprises defining a size of the host protected area on the one or more target hard disk drives.

11. The method of claim 8, further comprising protecting the host protected area on the one or more target disk drives after the creation of a host protected area and the copying of data to the host protected area are complete.

12. The method of claim 7, wherein the method is implemented in a hard disk drive duplication machine.

13. A computerized system, comprising:
a module operable to copy a data area of a source hard disk drive to one or more target hard disk drives;
a module operable to detect a host protected area of the source hard disk drive, and if a host protected area of the hard disk drive is detected further operable to copy the host protected area of the source hard disk drive to the one or more target hard disk drives.

14. The computerized system of claim 13, wherein copying the host protected area of he source hard disk drive to the one or more target hard disk drives comprises:
creating a host protected area on the one or more target hard disk drives; and
copying data from the host protected area of the source hard disk drive to the created host protected areas on the one or more target hard disk drives.

15. The computerized system of claim 14, wherein creating a host protected area on the one or more target hard disk drives comprises defining a logical block address LBA range on the one or more target hard disk drives for the host protected area.

16. The computerized system of claim 14, wherein creating a host protected area on the one or more target hard disk drives comprises defining a size of the host protected area on the one or more target hard disk drives.

17. The computerized system of claim 14, the module operable to create the host protected area on the one or more target hard disk drives further operable to protect the host protected area on the one or more target disk drives after the creation of a host protected area and the copying of data to the host protected area are complete.

18. The computerized system of claim 13, wherein the system is hard disk drive duplication system.

19. A computerized system comprising a module operable to detect a host protected area of a source hard disk drive, and if a host protected area of the source hard disk drive is detected further operable to copy the host protected area of the source hard disk drive to one or more target hard disk drives.

20. The computerized system of claim 19, wherein copying the host protected area of he source hard disk drive to the one or more target hard disk drives comprises:
creating a host protected area on the one or more target hard disk drives; and
copying data from the host protected area of the source hard disk drive to the created host protected areas on the one or more target hard disk drives.

21. The computerized system of claim 20, wherein creating a host protected area on the one or more target hard disk drives comprises defining a logical block address LBA range on the one or more target hard disk drives for the host protected area.

22. The computerized system of claim 20, wherein creating a host protected area on the one or more target hard disk drives comprises defining a size of the host protected area on the one or more target hard disk drives.

23. The computerized system of claim 20, the module operable to create the host protected area on the one or more target hard disk drives further operable to protect the host protected area on the one or more target disk drives after the creation of a host protected area and the copying of data to the host protected area are complete.

24. The computerized system of claim 19, wherein the system is hard disk drive duplication system.

25. A machine-readable medium with instructions thereon, the instructions when executed operable to cause a computerized system to perform operations comprising:
detecting a host protected area of a source hard disk drive if the source hard disk drive has a host protected area; and
copying the host protected area of the source hard disk drive to the one or more target hard disk drives if a host protected area was detected on the source hard disk drive.

26. The machine-readable medium of claim 25, wherein copying the host protected area of the source hard disk drive to the one or more target hard disk drives comprises:
creating a host protected area on the one or more target hard disk drives; and
copying data from the host protected area of the source hard disk drive to the created host protected areas on the one or more target hard disk drives.

27. The machine-readable medium of claim 26, wherein creating a host protected area on the one or more target hard disk drives comprises defining a logical block address LBA range on the one or more target hard disk drives for the host protected area.

28. The machine-readable medium of claim 26, wherein creating a host protected area on the one or more target hard disk drives comprises defining a size of the host protected area on the one or more target hard disk drives.

29. The machine-readable medium of claim 26, the instructions when executed further operable to cause the computerized system to perform operations comprising protecting the host protected area on the one or more target disk drives after the creation of a host protected area and the copying of data to the host protected area are complete.

30. The machine-readable medium of claim 25, wherein the computerized system comprises a hard disk drive duplication machine.
